(19) United States
(12) Patent Application Publication
(10) Pub. No.: US 2026/0188138 A1
(43) Pub. Date: Jul. 2, 2026

(54) APPARATUS FOR EVALUATING THE FINE MOTOR SKILL OF A TARGET USER

(71) Applicant: The Education University of Hong Kong, Hong Kong (CN)

(72) Inventors: Hong Fu, Hong Kong (CN); Zijian Luo, Hong Kong (CN); Yanyue Wang, Hong Kong (CN)

(21) Appl. No.: 19/005,107

(22) Filed: Dec. 30, 2024

(51) Int. Cl. G09B 11/00; G06V 10/82; G06V 40/20

(52) U.S. Cl. CPC G09B 11/00; G06V 10/82; G06V 40/20

(57) ABSTRACT

An apparatus for evaluating the fine motor skill of a target user includes: a pressure sensing module arranged to capture pressure data associated with the pressure exerted by small muscles of the target user during performance of the fine motor skill; a motion tracking module arranged to capture motion data associated with the movement of the small muscles of the target user during the performance of the fine motor skill; an eye tracking module arranged to capture gaze data associated with the gaze direction of the target user during the performance of the fine motor skill; and a performance evaluation module arranged to determine one or more metrics associated with the accuracy of the fine motor skill of the target user based on the captured motion data, the captured gaze data and the captured pressure data in real-time.

### TECHNICAL FIELD

The present invention relates to an apparatus for evaluating the fine motor skill of a target user, and particularly, but not exclusively, to an apparatus for evaluating the handwriting by a target user.

### BACKGROUND

According to the statistics of Education Bureau, there were 333,551 students registered in primary schools in Hong Kong in 2022/2023.

Handwriting, which could easily occupy up to 60% of the time in school, is an important task for children. During school hours, children spend approximately 30-60% of their time on fine motor activities, particularly writing tasks. Other fine motor activities such as manipulating play blocks, building of puzzles or models, or drawing, are important skills that are developed by children during their early years. As part of the child's development and ongoing education care, it would be beneficial to assess their performance early and provide any necessary correct, encouragement or intervention as soon as possible.

### SUMMARY OF THE INVENTION

In accordance with a first aspect of the present invention, there is provided an apparatus for evaluating the fine motor skill of a target user, comprising:
a pressure sensing module arranged to capture pressure data associated with the pressure exerted by small muscles of the target user during performance of the fine motor skill;
a motion tracking module arranged to capture motion data associated with the movement of the small muscles of the target user during the performance of the fine motor skill;
an eye tracking module arranged to capture gaze data associated with the gaze direction of the target user during the performance of the fine motor skill; and
a performance evaluation module arranged to determine one or more metrics associated with the accuracy of the fine motor skill of the target user based on the captured motion data, the captured gaze data and the captured pressure data in real-time.

In accordance with the first aspect, further comprising a user interactive panel arranged to collect the pressure data associated with the pressure exerted by the small muscle of the target user through a physical contact between the small muscle of the target user and the user interactive panel.

In accordance with the first aspect, the fine motor skill includes a writing task and the performance evaluation module is arranged to determine the stroke trajectory and stroke pressure of the writing task based on the pressure data associated with the pressure exerted by the small muscle of the target user through the physical contact between the small muscle of the target user and the user interactive panel.

In accordance with the first aspect, the fine motor skill includes writing task of a single word with multiple strokes and the pressure sensing module is arranged to capture the pressure data associated with the pressure exerted by small muscles of the target user in each stroke of the writing.

In accordance with the first aspect, the performance evaluation module is arranged to determine the starting segment and ending segment of the multiple strokes.

In accordance with the first aspect, the performance evaluation module is arranged to align the captured motion data and captured gaze data with the captured pressure data associated with the same segmentation of the multiple strokes.

In accordance with the first aspect, the performance evaluation module is arranged to receive a user input indicative of the time stamp associated with the performed fine motor skill.

In accordance with the first aspect, the motion tracking module comprises a plurality of camera units each capturing the movement of the target user from a different orientation.

In accordance with the first aspect, the performance evaluation module is arranged to compare body posture data derived from the captured motion data and the captured gaze data with handwritten data derived from the captured pressure data.

In accordance with the first aspect, the performance evaluation module is arranged to determine a joint stability (JS) of the target user during the performance of the fine motor skill based on the captured motion data.

In accordance with the first aspect, the pressure sensing module is arranged to capture the pressure variation (PV) of the pressure exerted by the small muscles of the target user during the performance of the fine motor skill.

In accordance with the first aspect, the performance evaluation module is arranged to determine a gaze stability index (GSI) associated with the fixation of the gaze direction of the target user during the performance of the fine motor skill based on the captured gaze data.

In accordance with the first aspect, the performance evaluation module is arranged to determine the pause duration (PD) during the performance of the fine motor skill based on the captured pressure data.

In accordance with the first aspect, the eye tracking module comprises a head-mounted eye tracker.

In accordance with the first aspect, the performance evaluation module further comprises a machine learning network model trained with a plurality of training data correlated with the performance of a fine motor skill by a plurality of test users.

In accordance with the first aspect, the plurality of training data comprises body position, concentration and pressure of the test users.

In accordance with the first aspect, the machine learning network model is configured to convert a plurality of training data associated with saccade, fixation and gaze duration of the test user into feature map.

In accordance with the first aspect, the machine learning network is configured to extract the concentration recognition from the feature map.

In accordance with the first aspect, the machine learning network further comprises Convolutional Neural Network (CNN) configured to extract the spatial feature from the feature map.

In accordance with the first aspect, the machine learning network further comprises Recurrent Neural Networks (RNN) and Artificial Neural Networks (ANN) configured to extract temporal feature from the feature map.

### BRIEF DESCRIPTION OF THE DRAWINGS

Embodiments of the present invention will now be described, by way of example, with reference to the accompanying drawings in which:

FIG. 1 is a schematic diagram of the overall architecture of an evaluating apparatus in accordance with one example embodiment of the present invention.

FIG. 2 is a schematic diagram showing a first stage of the training method of a machine learning network model in accordance with one example embodiment of the present invention.

FIG. 3 is a schematic diagram showing a second stage of the training method of a machine learning network model in accordance with one example embodiment of the present invention.

FIG. 4 is a schematic diagram showing a third stage of the training method of a machine learning network model in accordance with one example embodiment of the present invention.

FIG. 5 depicts stroke of good handwriting evaluated by the evaluating apparatus of FIG. 1.

FIG. 6 depicts stroke of bad handwriting evaluated by the evaluating apparatus of FIG. 1.

FIG. 7 depicts a fixation heatmap of a target user with good handwriting captured by the eye tracker of the apparatus of FIG. 1.

FIG. 8 depicts a fixation heatmap of a target user with bad handwriting captured by the eye tracker of the apparatus of FIG. 1.

FIG. 9 depicts a visual-motor integration of a target user with good handwriting captured by the apparatus of FIG. 1.

FIG. 10 depicts a visual-motor integration of a target user with bad handwriting captured by the apparatus of FIG. 1.

FIG. 11 depicts a three-dimensional stroke visualization of good handwriting captured by the apparatus of FIG. 1.

FIG. 12 depicts a three-dimensional stroke visualization of bad handwriting captured by the apparatus of FIG. 1.

FIG. 13A shows the graph of analyzed statement by a multi-modal handwriting analysis platform in accordance with one example embodiment of the present invention.

FIG. 13B shows the graph of analyzed statement by a multi-modal handwriting analysis platform in accordance with one example embodiment of the present invention.

FIG. 13C shows the graph of analyzed statement by a multi-modal handwriting analysis platform in accordance with one example embodiment of the present invention.

FIG. 14 is a splash screen showing the operation of the software interface in accordance with one example embodiment of the present invention.

FIG. 15 is a splash screen showing the operation of the software interface in accordance with another example embodiment of the present invention.

### DETAILED DESCRIPTION OF THE PREFERRED EMBODIMENTS

Without wishing to be bound by theory, the inventors have discovered that mainstream children's handwriting assessment solutions in the market focus on the alphabetic system, and Chinese handwriting presents unique challenges due to its complex strokes and spatial configurations.

At present, the mainstream writing assessment methods using artificial intelligence techniques in the market merely focus on computer vision techniques, which are the result of assessing children's writing after writing. In other words, the main AI-based handwriting assessment systems mainly collect offline data, that is, students write on paper, and then use computer vision methods to uniformly train the data and analyze and evaluate the writing results.

Secondly, many existing technologies are based on online writing platforms, using digital tablets to simulate writing scenes to obtain students' real-time writing data but this technical solution itself is not based on real writing scenes, so the scope of application is small, and this type of invention or research does not analyze and evaluate the writer's eye focus and body posture data, which will inevitably have the problem of low accuracy.

In practical applications, for example, in the scenario of assessing whether a student's writing is correct and beautiful, it is often necessary for a professional calligraphy teacher to first assess the characters, classify the data annotation as attractive/unattractive, correct/incorrect, and then train an AI model that meets the expectations by combining machine learning algorithms with computer vision-related technologies, which is a large amount of workload, and the degree of accuracy is often unsatisfactory.

In one aspect of the present invention, there is provided an Artificial Intelligence-based data collection and analysis system for eye tracks, body posture, writing tracks and pressure and accordingly, an intelligent writing evaluation system with high accuracy, high response, high integration and compact size which can solves one or more aforementioned problems.

More specifically, the present invention also provides a multimodal assessment scheme that highly integrates hardware devices such as eye-trackers, camera, and handwriting tablet. By using machine learning algorithms and eye tracking instruments, cameras, handwriting tablets, and other hardware devices for communication, the present invention can be applied to special education, primary and secondary school writing education, and other fields.

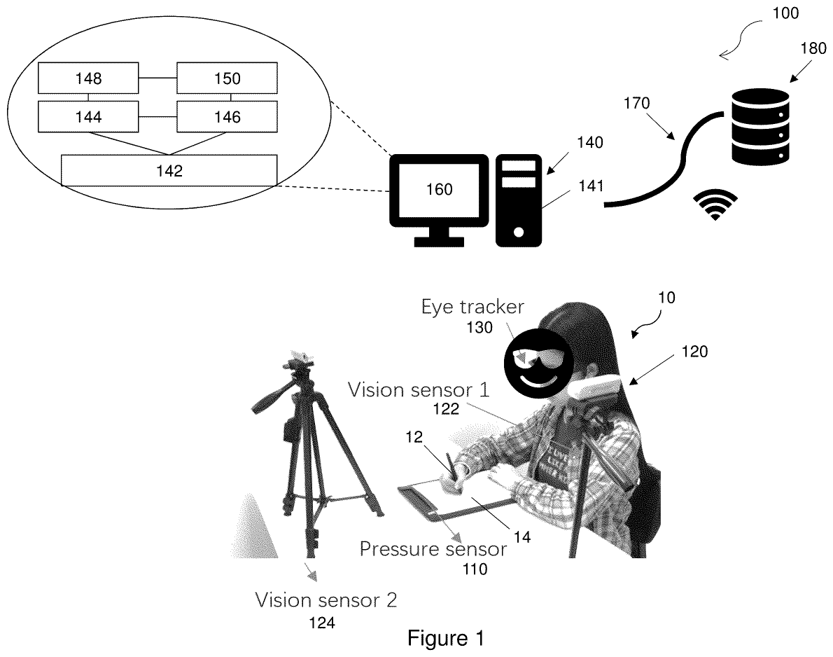

Referring to FIG. 1, there is shown an embodiment of the present invention. This embodiment is arranged to provide an apparatus 100 for evaluating the fine motor skill of a target user 10. The apparatus 100 for evaluating the fine motor skill of a target user 10 further comprises a pressure sensing module 110 arranged to capture pressure data associated with the pressure exerted by small muscles of the target user during performance of the fine motor skill. The apparatus 100 for evaluating the fine motor skill of a target user 10 further comprises a motion tracking module 120 arranged to capture motion data associated with the movement of the small muscles of the target user during the performance of the fine motor skill. The apparatus 100 for evaluating the fine motor skill of a target user 10 further comprises an eye tracking module 130 arranged to capture gaze data associated with the gaze direction of the target user during the performance of the fine motor skill. Finally, the apparatus 100 for evaluating the fine motor skill of a target user 10 further comprises a performance evaluation module 140 arranged to determine one or more metrics associated with the accuracy of the fine motor skill of the target user based on the captured motion data, the captured gaze data and the captured pressure data in real-time.

For the purposes of this patent document, the phrase “fine motor skill” refers to the coordination of small muscles in movement with the eyes, hands and fingers and includes any type of smaller movements that occur in the wrists, hands, fingers, feet and toes etc. The phrase “target user” includes children, patients or elderly. The phrase “metric” includes various parameters such as correctness and elegancy of handwriting, stroke similarity, fixation, visual-motor integration, stroke pressure variation etc.

Referring to FIG. 1 again for the further details of the overall architecture of a handwriting evaluation system 100 i.e., a Smart Writing System in accordance with one example embodiment of the present invention for evaluating the handwriting of a target user 10 with a writing instrument 12 e.g., pen or pencil on a medium such as a worksheet printed on a piece of paper 14.

Essentially, the handwriting evaluation system 100 comprises a pressure sensing module 110 for sensing the pressure exerted onto the worksheet 14 by the pen 12 held by the target user 10 during a handwriting session. There is also provided a motion tracking module 120 and an eye tracking module 130 for sensing the body posture of the target user 10 with respect to the worksheet 14. These modules are operable to capture pressure data, motion data and gaze data relevant to the handwriting performance. These signals are then processed by a performance evaluation module 140.

In one example embodiment, the pressure sensing module 110 may be embedded within a user interactive panel in the form of an intelligent handwriting tablet. The user interactive panel may collect the pressure data associated with the pressure exerted by the small muscle of the target user 10 through a physical contact between the small muscle of the target user 10 and the user interactive panel.

In one example embodiment, the motion tracking module 120 may further include one or more image capturing modules 122, 124 for capturing the posture data of the target user 10 during the handwriting session. For instance, the first image capturing module 122 may be a high-speed RGB camera for capturing a side 3D view of the target user 10 and the second image capturing module 124 may be another high-speed RGB camera for capturing a frontal 3D view of the target user 10. The posture data may include the limb e.g., neck and elbows actions of the target user 10 such as the limb angles with respect to a reference axis.

In one example embodiment, the eye tracking module 130 may be provided in the form of a head-mounted eye-tracker for capturing gaze data associated with the gaze direction of the target user 10 during the handwriting session. For instance, the eye tracking module 130 may send out one or more rays to detect the object or coordinates the target user 10 is looking at. More preferably, the eye tracking module 130 may send out multiple rays to detect the object or coordinates the left and right eyes of the target user 10 is looking at respectively. Accordingly, the eye tracking module 130 may precisely monitor and analyze the eye ball movements and the gaze direction of the eye balls with respect to the pen 12 or worksheet 14.

In one example embodiment, the performance evaluation module 140 may be provided for evaluating the handwriting based on some metrics and references. The performance evaluation module 140 may provide some rating scale based on the similarity between the stroke of the handwriting and the template stroke. For instance, various components of the handwriting evaluation system 100 can be coordinated to track different factors so as to generate one or more outputs based on the processed data.

For instance, the performance evaluation module 140 may determine the limb movements of the target user 10 e.g., left and right elbows, left and right necks based on the combination of the captioned motion data and the captioned gaze data. The performance evaluation module 140 may also determine the stroke trajectory and stroke pressure of the handwriting task based on the captured pressure data.

In one example embodiment, the performance evaluation module 140 may include a computing module 141 e.g., a laptop computer which comprises suitable components necessary to receive, store and execute appropriate computer instructions. The components may include a processing unit 142, including Central Processing Unit (CPUs), Math Co-Processing Unit (Math Processor), Graphic Processing Unit (GPUs) or Tensor Processing Unit (TPUs) for tensor or multi-dimensional array calculations or manipulation operations, read-only memory (ROM) 144, random access memory (RAM) 146, and input/output devices such as disk drives 148, a user interface 150 such as a keyboard, touchscreen. The processing unit 142 may be a single processor to provide the combined functions of multiple processors. In this example embodiment, the computing module 141 is configured to receive data associated with the handwriting exercise performed by the target user 10 and the environment measured by external sensing units 110, 120, 130.

The computing module 141 may comprise other input devices such as an Ethernet port, a USB port, etc. Display 160 such as a liquid crystal display, a light emitting display or any other suitable display and communications links (i.e., a communication interface) 170. The display 160 may graphically represent a template character written by experts so that the target user 10 may follow the stroke in the handwriting exercise.

The computing module 141 may include instructions that may be included in the ROM 144, RAM 146, or disk drives 148 and may be executed by the processing unit 142. There may be provided with one or more communication interfaces (i.e., one or more communication links) which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link. The communication interface is configured to allow communication of data via any suitable communication network using any suitable protocol such as for example Wi-Fi, Bluetooth, 4G, 5G or any other suitable protocol.

The performance evaluation module 140 may further comprise a machine learning network model which is pretrained with a plurality of training data correlated with the performance of a fine motor skill by a plurality of test users. The machine learning network model may be locally stored in the read-only memory (ROM) 144 or remotely stored on a cloud server 180. Accordingly, the data can be AI-processed locally on the computing module 141 or alternatively sent to a cloud server 180 via communication network 170 for processing with other data and analysis. Advantageously, each round of evaluation of the handwriting of a target user 10 may also be used for retraining the machine learning network model of the performance evaluation module 140.

In one example embodiment, the technical solution adopted in the present invention comprises a multimodal data analysis system 100 including a head-mounted eye-tracker 130, two high-speed RGB cameras 122, 124, an intelligent handwriting tablet 110, and a laptop computer 141 running a software system.

Taking the laptop 141 equipped with the Smart Writing System 100 as the core, it may coordinate the head-mounted eye-tracking device 130, high-speed RGB camera 120, intelligent handwriting board 110 and other hardware devices, and interacts with the data of each hardware through real-time communication protocols. After collecting the data, machine learning algorithms are used to scientifically analyze and evaluate the writing results.

In one preferred embodiment, the computing module 141 may further store a core algorithm as one or more executable instructions in the read-only memory (ROM) 144 and may be executed by the processing unit 142. The core algorithm may comprise a data alignment algorithm and a stroke splitting algorithm.

For instance, the data alignment algorithm may be achieved through a platform developed by an operating system such as python. In particular, the system 100 splits multiple threads to listen to the RGB camera 120 and scene camera 130 in real time and transfer the data to the thread processing program 140 in a streaming way. Through the frame cutting and frame synchronization algorithms, the system 100 compares the body posture data recorded by the cameras 122, 124 with the handwritten data, and ultimately compare the data of the different devices, which will provide valuable raw data for the subsequent evaluation of the overall writing quality.

Regarding the stroke splitting algorithm, the present invention provides a unique solution for extracting children's writing strokes with 100% accuracy and eventually saving the writing data as a single word, as a basis for data analysis. For instance, the system 100 may receive a signal input from the target user 10 indicating the beginning of the single word writing task and the end of the single word writing task.

In one specific embodiment, the Smart Writing System 100 may further include a push button (not shown) which is in signal communication with the computing module 141 e.g., via USB or other wireless signal communication where the child 10 may presses the push button upon completing the single word writing task to align the strokes with the data captured by the eye-tracker 130 and camera 120 to calculate a smaller granularity of data. When the push button is pressed after the child 10 completes the single word writing task, the computing module 141 can save the data of the single writing task, and then distribute the pressure value of the writing to calculate the data of the stroke as the starting and ending segments, and then align the data with the data captured by the eye-tracking device 130 and the camera 120, and ultimately realize the segmentation of the strokes, extracting, and calculating the strokes.

The present invention also innovates a novel artificial intelligence platform for handwriting quality assessment that incorporates multimodal features such as gaze stability index (GSI), pressure variation (PV), joint stability (JS), pause duration (PD), etc., and is able to give highly accurate handwriting quality assessment results based on the real children's handwriting process, and to provide effective guiding advice for improving children's handwriting quality.

For instance, the gaze stability index (GSI) is associated with the fixation of the gaze direction of the target user 10 during the handwriting and can be determined based on the captured gaze data by the eye-tracker 130. The pressure variation (PV) is associated with the pressure exerted by the small muscles of the target user 10 during the handwriting and can be determined based on the captured pressure data by the pressure sensing module 110. The joint stability (JS) is associated with the limb action of the target user 10 during the handwriting and can be determined based on the captioned motion data by the motion tracking module 120. The pause duration (PD) is associated with the accumulated pause between successive strokes in a single word handwriting task and can be determined based on the captured pressure data by the pressure sensing module 110.

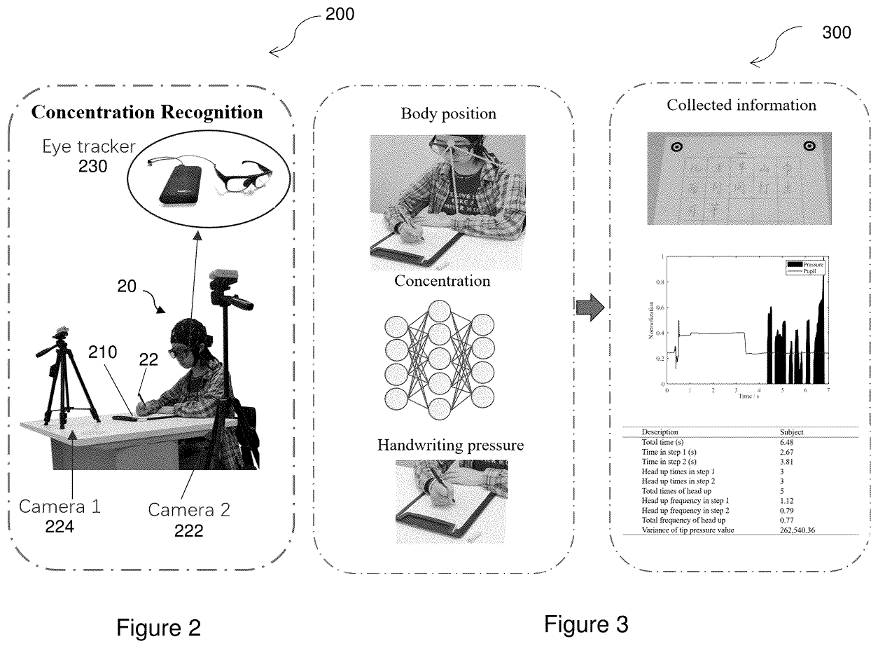

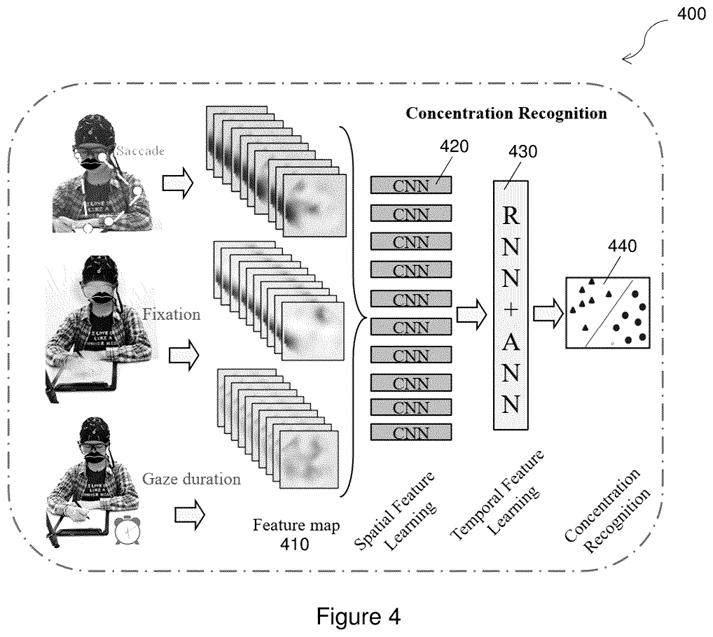

With reference to FIGS. 2 to 4, there is shown the training method of a machine learning network model in accordance with one example embodiment of the present invention. Illustratively, the implementation of the training method may be based on three main stages e.g., an initial stage of data collection (step 200), intermediate stage of data analysis (step 300) and final stage of training models (step 400).

### Stage 1: Data Collection

In this example embodiment, there is provided a multi-modal data collection system which is trained based on eye movements, body posture, writing handwriting, pressure and other data and the training of the system requires collecting a large amount of children's writing data. In one pretraining setup as shown in FIG. 2, there is provide a similar setup as the aforementioned handwriting evaluation system 100 and comprises a user interactive panel 210, a pair of high-speed RGB camera 222, 224, and a head-mounted eye-tracker 230 for capturing the data associated with the handwriting task performed with a writing instrument 22 by a test user 20.

### Stage 2: Data Analysis

Based on the analysis of the massive amount of data, the inventors learned the factors that are significantly correlated with children's writing quality. For instance, the body position, concentration of the test user 20 and the handwriting pressure by the pen tip are significantly correlated with children's writing quality and the information are collected accordingly.

### Stage 3: Training Models

Using the processed data, the present inventor trained an artificial intelligence model using deep learning techniques that can effectively assess children's writing quality. The machine learning network model is configured to convert a plurality of training data associated with saccade, fixation and gaze duration of the test users 20 into feature map 410 for mapping data vector to feature space. The machine learning network model may include Convolutional Neural Network (CNN) for providing spatial feature learning 420 from the feature map 410. The machine learning network model may also include Recurrent Neural Networks (RNN) and Artificial Neural Networks (ANN) 430 configured to extract temporal feature from the feature map 410. Accordingly, the machine learning network model may achieve the concentration recognition associated with the tested user 20. In contrast with the present technology, the spatio-temporal fusion model of the present invention may combine dynamic and morphological features and can improve the accuracy of handwriting quality assessment.

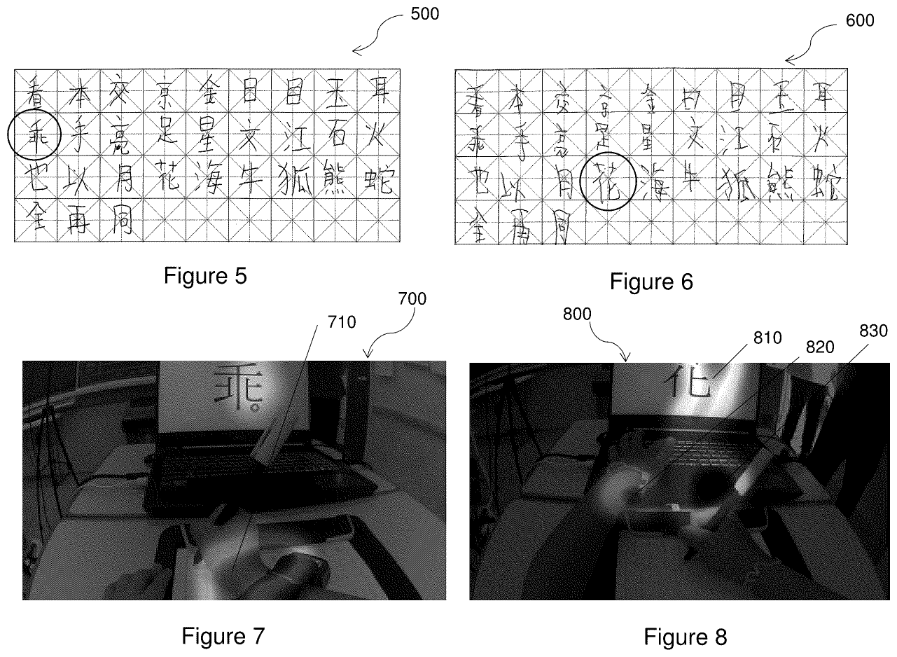

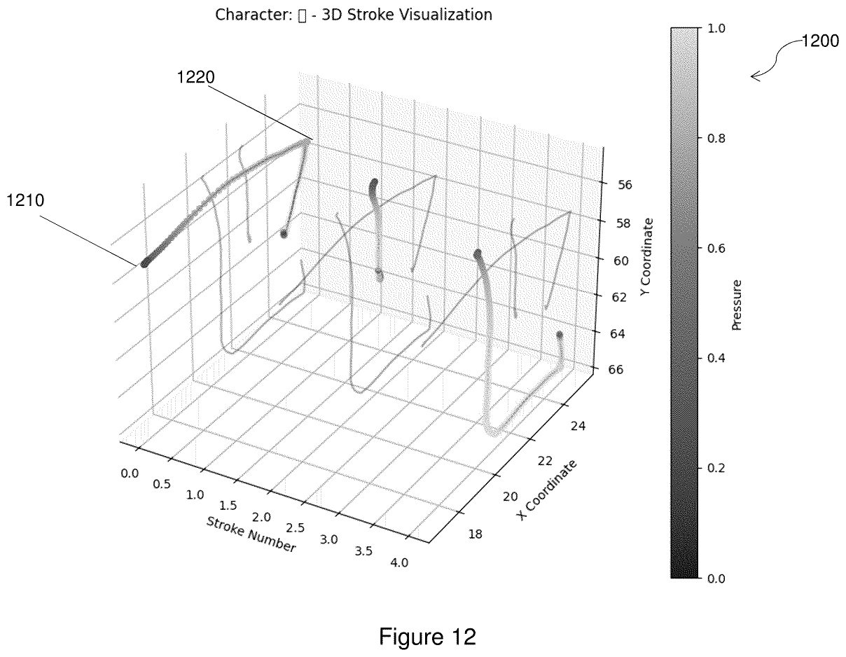

The parameters or metrics for evaluating the quality of the handwriting by the performance evaluation module 140 will now be further explained with reference to FIGS. 5 to 12. For instance, the evaluation of the handwriting may be quantified by various metrics such as stroke similarity score, fixation heatmap, visual-motor integration and stroke pressure variation.

In one example embodiment, a plurality of testing targets 10 e.g., a group of children are required to complete the same writing task of some Chinese characters and the handwriting would be evaluated by the performance evaluation module 140.

FIG. 5 shows a good handwriting 500 by a first tested child while FIG. 6 shows a bad handwriting 600 by a second tested child. A comprehensive assessment has been conducted with reference to several dimensions, see below table:

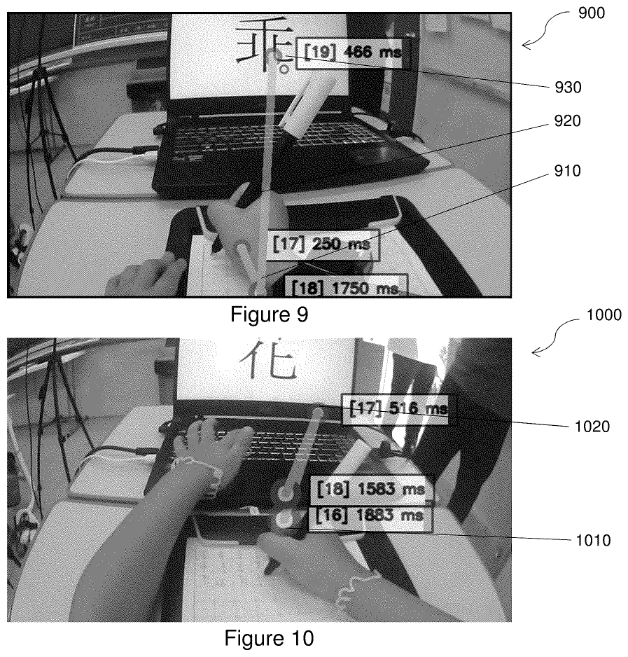

TABLE 1
Comprehensive Assessment of Children's Handwriting
Ability Based on Eye Movement Data.

| Dimensions | Good | Bad |
|---|---|---|
| Stroke Similarity Score | Human scoring: 90 | Human scoring: 50 |
| | Al scoring: 60.35477149 | Al scoring: 37.9288328994769 |
| Fixation Heatmap | FIG. 7 | FIG. 8 |
| Visual-motor integration | FIG. 9 | FIG. 10 |
| Stroke Pressure Variation | Stroke Pressure Variation: | Stroke Pressure Variation: |
| | 389.660 | 547.628 |

### A. Stroke Similarity Score:

After processing the data through the aforementioned stroke splitting algorithm, the slope and curvature of individual strokes are calculated separately. Based on the above data, the stroke similarity between the template characters written by experts and those written by children is calculated, and the value is compressed to the range of 0 to 100.

Illustratively, the good handwriting 500 as shown in FIG. 5 scores 90 by the evaluation of human expert while the bad hand writing 600 as shown in FIG. 6 scores only 50 by the evaluation of the same human expert. The stroke similarity score obtained by the good handwriting 500 is 60 while the stroke similarity score obtained by the bad handwriting 600 is only 38. Based on the comparison between the stroke similarity score and the evaluation by the human expert, it shows a positive correlation between the quality of the handwriting i.e., the human scoring and the AI scoring assessed based on the stroke similarity.

The fixation heatmap and the visual-motor integration are also determined during the handwriting task. For illustration, the fixation heatmap and the visual-motor integration of a single handwriting task of the Chinese character “ [symbol] ” are recorded by FIGS. 7 and 9 respectively while the fixation heatmap and the visual-motor integration of a single handwriting task of the Chinese character “ [symbol] ” are recorded by FIGS. 8 and 10 respectively.

### B. Fixation Heatmap:

The gaze direction of the testing target 10 is captured by the eye tracker 130 and plotted in the form of heatmaps 700, 800. The heatmap 700 of the child 10 with good handwriting shows that the gaze direction of the children is concentrated on the worksheet area 710 whilst the heatmap 800 of the child 10 with bad handwriting shows that the gaze direction of the children is distracted by the screen region 810, left hand region 820 and the keyboard region 830. According to the eye tracker gaze aggregation for fixation generation, the fixation of the children with good handwriting is more concentrated, while that of the children with bad handwriting is more dispersed.

### C. Visual-Motor Integration:

The writing ability is defined by hand-eye co-ordination coefficient, and generally children who write well have a more stable fixation path and only dwell on necessary information (worksheets, pens, screens).

The posture data of the testing target 10 e.g., hand movements are captured by the image capturing modules 122, 124 while the gaze direction of the eyes is captured by the eye tracker 130. The fixation path in the integration 900 of the child 10 with good handwriting shows that the children only dwell on necessary information within the worksheet region 910, pen region 920 and screen region 930 whilst the fixation path in the integration 1000 of the child 10 with bad handwriting shows that the children dwell on some unnecessary information about the keyboard area 1010 apart from the screen region 1020.

### D. Stroke Pressure Variation:

The stroke and writing data are captured by the pressure sensing module 110 and processed for projecting in a 3D visualization of X coordinate, Y coordinate and stroke number. In particular, the pressure magnitude of each stroke is captured by the pressure sensing module 110 and the pressure variation between the consecutive strokes are then calculated.

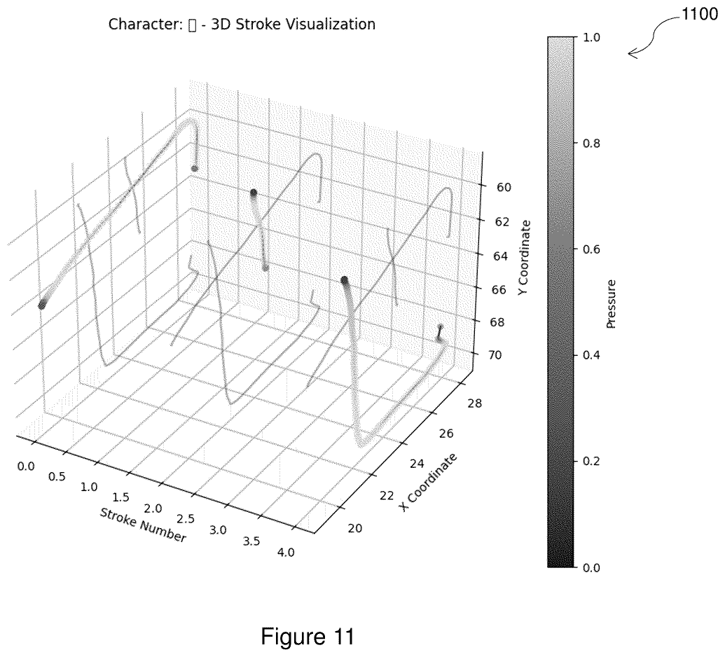

The 3D stroke visualization 1100 of the child 10 with good handwriting shows that the pressure of each stroke of the single word writing is consistent while the 3D stroke visualization 1200 of the child 10 with bad handwriting shows that the pressure of each stroke of the single word writing is inconsistent, with low pressure at the beginning 1210 of each stroke and towards the end 1220 of each stroke. By reproducing the pressure distribution of the strokes through 3D visualisation, children with good writing quality have less variation in the pressure of the pen tip when writing, as shown in FIG. 11, and the overall colour is more even. For instance, the stroke pressure variation of the 3D stroke visualization 1100 for good handwriting 500 as shown in FIG. 5 is 389.660 while the stroke pressure variation of the 3D stroke visualization 1200 for bad handwriting 600 as shown in FIG. 6 is 547.628 which is much higher than that of the good writing 500.

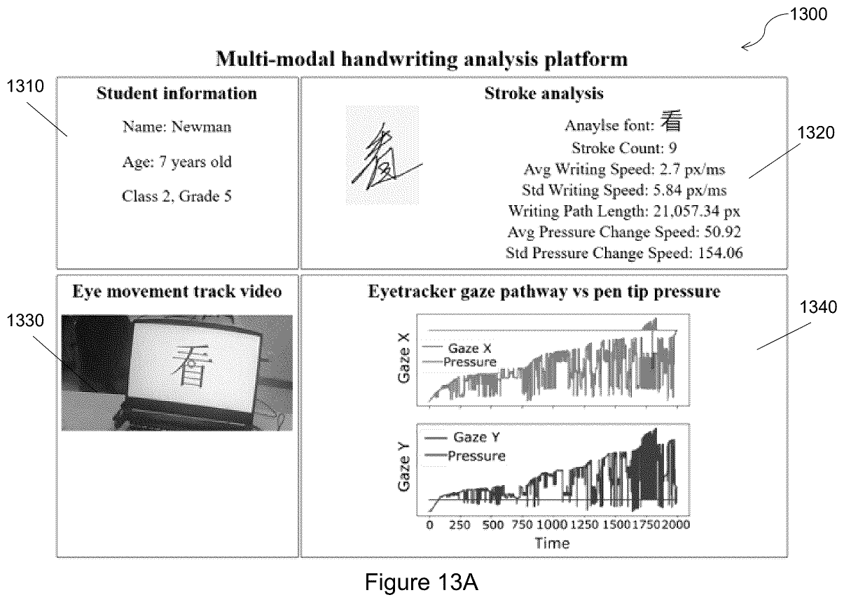

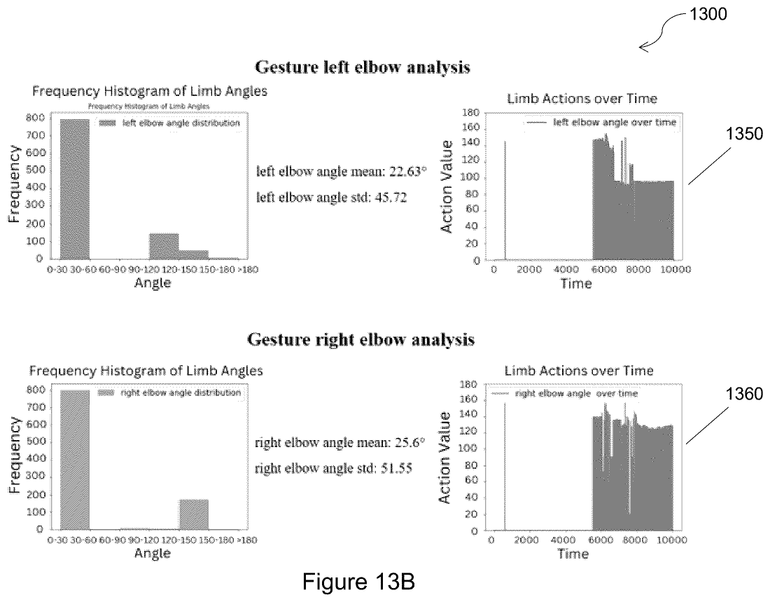

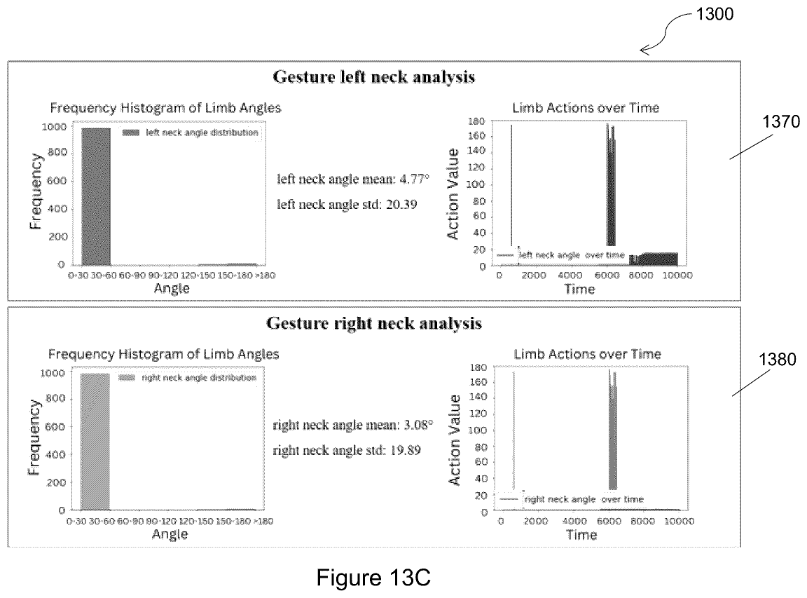

The details of the multi-modal handwriting analysis platform in accordance with one example embodiment of the present invention will now be described with reference to FIGS. 13A to 13C. A target user 10 is tested under the handwriting evaluation system 100 in accordance with one example embodiment of the present invention and an interface 1300 of the multi-modal handwriting analysis platform as shown in FIGS. 13A to 13C which depicts the testing results.

In particular, a tested student 10 is required to perform a single writing task of the Chinese character “ [symbol] ”. The student information is recorded by the bibliography section 1310. A stroke analysis is performed based on the pressure data captured by the pressure sensing module 110 and the information of the analysis is displayed on the analysis section 1320. For instance, the analysed font, stroke count, average writing speed, standard writing speed, writing path length, average pressure change speed, and standard pressure change speed are determined and displayed on the analysis section 1320.

The gaze data of the left and right eyes captured by the eye-tracker 130 is processed and graphically represented by an eye movement track video 1330. The X and Y coordinates of the gaze direction are also plotted against the pressure of the pen tip recorded by the pressure sensing module 110 in the plot section 1340 respectively.

Preferably, the gaze data captured by the eye-tracker 130 and the posture data captured by the image capturing modules 122, 124 may be processed by the processor 142 so as to determine the gesture of the tested student 10. For instance, the captured motion data in the images and the gaze direction may be processed to determine the limb movement of the tested student 10 such as the left and right elbow angles and the left and right neck angles respectively. The limb action of elbows and neck are recorded over time and the frequency of different angle ranges are also recorded. The mean angle and the standard angle of the limb are also calculated.

For instance, the frequency histogram of the left elbow angle and the left elbow angle over time are shown in the gesture left elbow analysis section 1350, and the frequency histogram of the right elbow angle and the right elbow angle over time are shown in the gesture right elbow analysis section 1360 respectively. Similarly, the frequency histogram of the left neck angle and the left neck angle over time are shown in the gesture left neck analysis section 1370, and the frequency histogram of the right neck angle and the right neck angle over time are shown in the gesture right neck analysis section 1380 respectively.

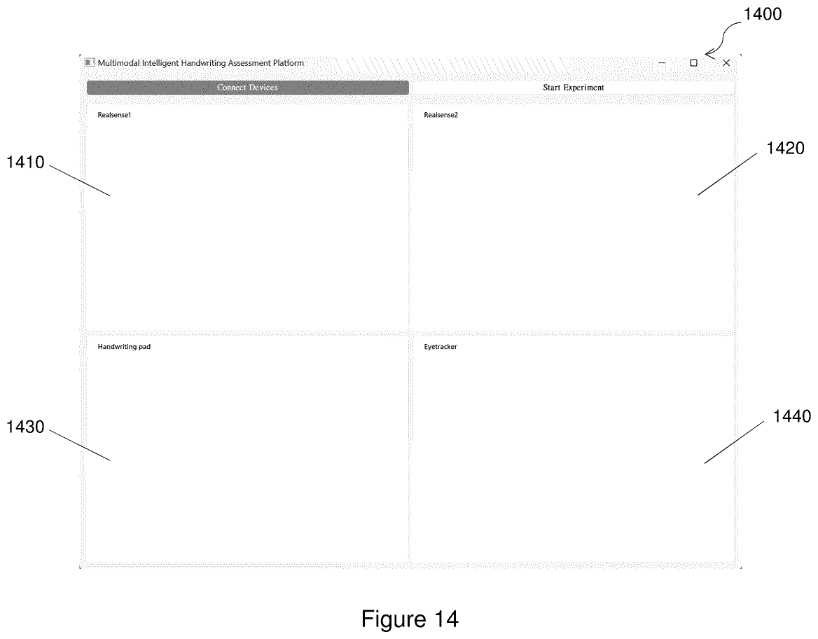

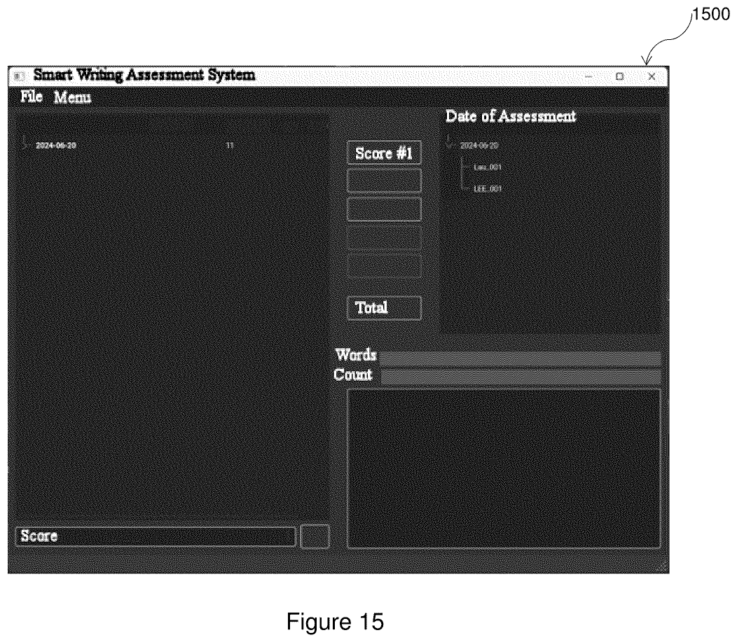

Finally, the operation of the software interface in accordance with one example embodiment of the present invention will now be described with reference to FIGS. 14 to 15.

FIG. 14 depicts an interface 1400 of the multimodal intelligent handwriting assessment platform which may graphically present the corresponding data onto a display panel. The “Realsense1” sector 1410 depicts the motion data captured by the first high-speed RGB camera 122 while the “Realsense2” sector 1420 depicts the motion data captured by the second high-speed RGB camera 124. The “Handwriting pad” sector 1430 depicts the pressure data captured by the pressure sensing module 110 while the “Eyetracker” sector 1440 depicts the gaze data captured by the eye tracker 130.

FIG. 15 depicts another interface 1500 of the multimodal intelligent handwriting assessment platform which is a master data management database. A plurality of target users 10 may be tested by the handwriting evaluation system 100 and subsequently stored for further analysis.

Advantageously, the present invention is based on the self-designed and self-trained AI model with multi-modal data, which can maximally restore the children's writing process in real-life scenarios. The modalities include eye movement, skeleton, stroke trajectory, stroke pressure and so on. The present invention also provides a handwriting quality assessment platform for children based on the fusion of multi-modal data and combining the training of artificial intelligence techniques such as deep learning, which integrates eye movements, pressure changes and skeletal dynamics data to provide higher accuracy and reliability than other handwriting quality assessment platforms.

Advantageously, the technical solution of the present invention results in multiple beneficial effects. By implementing a multimodal fusion writing quality assessment system based on machine learning algorithms, this extends the data collection range of traditional writing scenarios and adds hardware devices such as eye-tracker and camera. The writing assessment based on real scenarios significantly improves data accuracy and dynamic response capability. At the same time, it meets the requirements of high integration, synchronous alignment of data from multiple hardware devices, unified management, statistics and analysis. The architecture of the present invention is also suitable for special education, and primary and secondary school students of all ages to improve the quality of writing and assessment, the application prospect is broad.

The invention has been given by way of example only, and various other modifications of and/or alterations to the described embodiment may be made by persons skilled in the art without departing from the scope of the invention as specified in the appended claims. It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. An apparatus for evaluating the fine motor skill of a target user, comprising:
a pressure sensing module arranged to capture pressure data associated with the pressure exerted by small muscles of the target user during performance of the fine motor skill, wherein the fine motor skill includes a writing task of one or more words;
a motion tracking module arranged to capture motion data associated with the movement of the small muscles of the target user during the performance of the fine motor skill;
an eye tracking module arranged to capture gaze data associated with a gaze direction of the target user during the performance of the fine motor skill; and
a performance evaluation module arranged to:
align the captured motion data and captured gaze data with the captured pressure data associated with writing of the one or more words in the writing task to form aligned data;
compare body posture data derived from the captured motion data and the captured gaze data with handwritten data derived from the captured pressure data to form compared data; and
determine a plurality of multimodal metrics of the aligned data and the compared data in real-time, wherein the plurality of multimodal metrics are associated with an accuracy of the fine motor skill of the target user.

2. An apparatus in accordance with claim 1, further comprising a user interactive panel arranged to collect the pressure data associated with the pressure exerted by the small muscle of the target user through a physical contact between the small muscle of the target user and the user interactive panel.

3. An apparatus in accordance with claim 2, wherein the writing task includes a stroke trajectory and a stroke pressure, and the performance evaluation module is arranged to determine the stroke trajectory and stroke pressure of the writing task based on the pressure data associated with the pressure exerted by the small muscle of the target user through the physical contact between the small muscle of the target user and the user interactive panel.

4. An apparatus in accordance with claim 3, wherein the fine motor skill includes writing task of a single word with multiple strokes and the pressure sensing module is arranged to capture the pressure data associated with the pressure exerted by small muscles of the target user in each stroke of the writing.

5. An apparatus in accordance with claim 4, wherein the performance evaluation module is arranged to determine the starting segment and ending segment of the multiple strokes.

6. An apparatus in accordance with claim 5, wherein the performance evaluation module is arranged to align the captured motion data and captured gaze data with the captured pressure data associated with the same segmentation of the multiple strokes.

7. An apparatus in accordance with claim 6, wherein the performance evaluation module is arranged to receive a user input indicative of a time stamp associated with the performed fine motor skill.

8. An apparatus in accordance with claim 1, wherein the motion tracking module comprises a plurality of camera units each capturing the movement of the target user from a different orientation.

9. An apparatus in accordance with claim 1, wherein the plurality of multimodal metrics includes at least a joint stability (JS), a gaze stability index (GSI), a pressure variation (PV) and a pause duration (PD).

10. An apparatus in accordance with claim 9, wherein the performance evaluation module is arranged to determine the joint stability (JS) of the target user during the performance of the fine motor skill based on the captured motion data.

11. An apparatus in accordance with claim 9, wherein the pressure sensing module is arranged to capture the pressure variation (PV) of the pressure exerted by the small muscles of the target user during the performance of the fine motor skill.

12. An apparatus in accordance with claim 9, wherein the performance evaluation module is arranged to determine the gaze stability index (GSI) associated with the fixation of the gaze direction of the target user during the performance of the fine motor skill based on the captured gaze data.

13. An apparatus in accordance with claim 9, wherein the performance evaluation module is arranged to determine the pause duration (PD) during the performance of the fine motor skill based on the captured pressure data.

14. An apparatus in accordance with claim 1, wherein the eye tracking module comprises a head-mounted eye tracker.

15. An apparatus in accordance with claim 1, wherein the performance evaluation module further comprises a machine learning network model trained with a plurality of training data correlated with a performance of a fine motor skill by a plurality of test users.

16. An apparatus in accordance with claim 15, wherein the plurality of training data comprises body position, concentration and pressure of the test users.

17. An apparatus in accordance with claim 15, wherein the machine learning network model is configured to convert a plurality of training data associated with saccade, fixation and gaze duration of the test user into a feature map.

18. An apparatus in accordance with claim 17, wherein the machine learning network is configured to extract a concentration recognition from the feature map.

19. An apparatus in accordance with claim 18, wherein the machine learning network further comprises Convolutional Neural Network (CNN) configured to extract a spatial feature from the feature map.

20. An apparatus in accordance with claim 18, wherein the machine learning network further comprises Recurrent Neural Networks (RNN) and Artificial Neural Networks (ANN) configured to extract a temporal feature from the feature map.
